(19) United States
(12) Patent Application Publication
(10) Pub. No.: US 2011/0195272 A1
(43) Pub. Date: Aug. 11, 2011

(54) PROCESS FOR THE PROTECTION OF A METAL SUBSTRATE FROM CORROSION AND ABRASION, AND METAL SUBSTRATE OBTAINED BY THIS PROCESS

(75) Inventors: Sylvie Guibert-Claverie, Taillis (FR); Yvan Thareau, La Rheu (FR)

(73) Assignee: DALIC, Vitre (FR)

(21) Appl. No.: 13/022,853

(22) Filed: Feb. 8, 2011

(30) Foreign Application Priority Data
Feb. 8, 2010 (FR) 10 50861

(51) Int. Cl. B32B 15/01; B05D 3/00; C25D 5/48; C25D 5/06; B05D 3/12

(52) U.S. Cl. 428/650; 427/331; 205/220; 205/117; 427/367

(57) ABSTRACT

A process is provided for the protection of a metal substrate of an aircraft part, in particular made of aluminum alloy, from corrosion and abrasion. The method includes the formation, on the substrate, of a coating made of alloy of zinc and nickel and then polishing the coating thus formed. This process can additionally include applying, to the polished coating made of alloy of zinc and nickel, a transparent and airtight surface coating.

### BACKGROUND OF THE INVENTION

1. Field of the Invention

A subject matter of the present invention is a process for the protection of a metal substrate, in particular made of aluminum alloy, from corrosion and abrasion.

2. Description of the Related Art

Such a process has application in particular in the field of aeronautics, a field in which some aircraft parts made of aluminum alloy are subjected in flight to phenomena of abrasion and corrosion; these same parts are furthermore susceptible to being scratched or subjected to impacts during their residence on the ground or their manufacture.

There additionally exists, in this same field of aeronautics, a demand for some external surfaces of aircraft to have a shiny appearance.

To date, the aircraft parts mentioned above are essentially protected by two processes.

The first of these processes comprises an anodization treatment (carried out in a tank), of chromic acid or sulfuric acid type, of said parts, followed by the application of a protective paint and/or of a varnish to the parts thus treated.

The second of these processes comprises the use in these aircraft parts of an aluminum sheet coated with an aluminum plating, this plating being polished in order to confer thereon a “mirror finish” finishing.

There are many disadvantages to these processes.

Thus, they do not make possible satisfactory protection from corrosion, abrasion, scratches and impacts, with the harmful consequence of losses in thickness (weakening) and the formation of localized corrosion pits of variable depth.

Furthermore, the process based on the anodization does not make it possible to obtain the shine required in some cases.

Furthermore, the use of a plating, which usually represents from 5 to 10% of the thickness of the aircraft parts concerned, is problematic to implement and results in an appreciable additional material cost.

In addition, the coatings obtained with the known polished plating process are difficult to repair; this is because, in this case, repair requires a sanding, which can affect the substrate-plating integrity by perforating the plating and can result in the replacement of the sheet, which is a very complex and expensive operation.

### SUMMARY OF THE INVENTION

The aim of the present invention is to overcome these inadequacies of the processes of the prior art and, to this end, the present invention provides a process for the protection of a metal substrate of an aircraft part, in particular made of aluminum alloy, from corrosion and abrasion, which is characterized in that it comprises the formation, on said substrate, of a coating made of alloy of zinc and nickel (abbreviated to Zn—Ni) and then the polishing of the coating thus formed.

### DETAILED DESCRIPTION OF THE PREFERRED EMBODIMENTS

This coating exhibits good adhesion to the substrate and also a greater hardness (250-300 VH) than that obtained with the unanodized aluminum (25-120 VH).

The treated substrate thus exhibits, due to its increased hardness, better protection from abrasion, scratches and impacts, which increases the intervals between the maintenance operations and facilitates the maintenance itself.

This treated substrate is also superior, in terms of corrosion resistance, to polished aluminum substrates.

Thus, a treated substrate makes it possible to obtain a duration of protection in salt spray of more than 400 hours before the appearance of corrosion on this substrate, whereas, in the case of the plated and polished aluminum process, corrosion appears within the first 20 hours of exposure to salt spray.

In addition, the choice of Zn—Ni alloy generates a galvanic couple with the aluminum substrate favorable to the protection thereof, also in the case where a local repair (case of pits or deep impacts) would have been carried out using a deposition of nickel, if the latter is covered with a Zinc-Nickel finishing layer.

Furthermore, the coating according to the invention can, in the event of the appearance of cracks or scratches, be repaired by simple localized contribution of Zn—Ni alloy by the brush plating technique, followed by polishing the regions affected by this contribution of alloy.

In addition to the fact that it fully responds to the constraints of attractiveness imposed by some airlines, the mirror finish appearance obtained according to the invention by the polishing operation is at least of as good quality as that obtained currently by polishing an aluminum plating; for this reason, it makes possible an improvement in the flow of the air and consequently might bring about a saving in fuel with respect to an unpolished structure.

According to a preferred embodiment, recourse may be had, for the deposition of Zn—Ni, to the well known technique of electrodeposition, in particular out-of-tank electrodeposition, for example by brush plating, which makes it possible to locally treat the substrate and to retain its geometrical stability and is perfectly suited to the manufacturing cycle for these parts, which may require assembling operations and protection by other processes on their other face.

According to one embodiment, the electrodeposition comprises the use of an electrolytic solution comprising Ni²⁺ and Zn²⁺ ions, the concentration of the Ni²⁺ ions being from 9 to 49 g/l and the concentration of the Zn²⁺ ions being from 49 to 90 g/l.

Advantageously, said concentrations of Ni²⁺ and Zn²⁺ ions are chosen in order to form a coating comprising from 5 to 20% by weight, preferably from 10 to 14% by weight, of nickel.

It should be added that the source of Ni²⁺ ions can, for example, comprise nickel chloride (for example hydrate) and the source of Z ²⁺ ions can, for example, comprise zinc oxide.

According to the invention, the polishing of the coating made of Zn—Ni alloy is not limited to a particular technique and can call on manual or mechanical sanding (in particular rotary sander or robot), in particular using an abrasive material, such as a sandpaper or a polishing paste.

According to the invention, the formation of the coating made of zinc-nickel alloy and the polishing are, for example, carried out in order to obtain, before polishing, a coating with a thickness of from 30 to 50 μm and, after polishing, a coating with a thickness of from 20 to 45 μm.

The process according to the invention can in addition advantageously comprise the application, to the polished coating made of alloy of nickel and zinc, of a transparent and airtight surface coating.

This surface coating, for example applied by spraying, aerosol or with a brush, with a thickness which can vary up to 40 μm, as the case may be, can, inter alia, comprise one or more polymers chosen from the group consisting of acrylic resins, epoxy resins, silicones, polysilanes, sol/gels and polyurethanes or can be the result of a passivation without hexavalent chromium.

Mention may be made, by way of examples, of the surface-coating compositions sold by Socomor, Coventya, Cytec, Map and Akzo Nobel.

Said surface coating will make it possible in particular to slow down and limit the oxidation of the Zn—Ni coating which occurs in particular in humid and marine atmospheres.

With regard to the metal substrate to be treated, they can be substrates made of aluminum alloy (for example, alloy 2024 or 2219) or substrates made of steel which are generally exposed to phenomena of abrasion and of corrosion, as is the case in the aero-nautical field, leading edges or slats, ailerons or vertical stabilizers of airplanes, engine nacelle air inlets of airplanes, supporting structures for cabin windows or cockpits of airplanes, edges of propellor blades of airplanes or helicopters and some landing gear components.

Another subject matter of the present invention is the protected metal substrate obtained by the process described above in which the coating exhibits a mirror finish.

The present invention will now be illustrated by the additional description below.

The application of the coating made of alloy of nickel and zinc is preferably preceded by the preparation of the surface of the substrate to be treated.

The aim of this preparation is to degrease this surface and, if need be, to strip the latter in order to remove therefrom the surface oxides, impurities and grease and to thus make possible optimum adhesion of the coating.

According to the nature of the substrate (aluminum alloy or steel) and the surface condition of the latter, said preparation can comprise a sanding, followed by one or more of the following operations: chemical or electrochemical degreasing, chemical or electrochemical stripping, sandblasting by the wet or dry route, chemical or electrochemical depassivation, chemical or electrochemical activation and optional formation of a metal undercoat, with rinsing with water between these various operations.

Recourse is preferably made, in producing the zinc-nickel coating, to the out-of-tank electrodeposition technique.

To this end, use can be made of well known brush plating tools. The conditions employed for the electrodeposition are as follows:

composition of the electrolyte:
zinc oxide: from 62 to 113 g/l
nickel chloride hexahydrate: from 38 to 205 g/l
sulfamic acid: amount necessary for the dissolution of the zinc salt
basic agent: amount necessary to adjust the pH to between 8 and 10
demineralized water: for adjusting to volume

anode: graphite, platinum-coated titanium, platinum

current: continuous or pulsating

voltage: less than 20 V

current density: from 50 to 300 A/dm²

duration: from 7.7 to 9.6 minutes for a thickness of deposition of from 40 to 50 μm over 1 dm², taking into consideration an electrode coverage of 10% of the surface to be treated and a current density of 200 A/dm² in contact.

After rinsing the substrate which has received its coating, the latter is subjected to a polishing operation by employing the techniques listed above, until a mirror finish is obtained which meets the requirements of the manufacturers and their customers.

If desired, the above process is completed by a stage of application, to the polished Zn—Ni coating, for example by spraying, of an airtight surface coating having the thickness and the composition mentioned above.

Some characteristics of the polished Zn—Ni coating were tested, in particular its adhesion to the substrate, its hardness, its corrosion resistance and its thermal shock resistance.

The adhesion to the substrate was confirmed by a micro sectioning during polishing operations which significantly stress the deposited layer and during thermal shock tests comprising 9 cycles between −80° C. and +200° C., with direct passage from one temperature to the other.

The hardness was measured by recognised conventional methods.

The corrosion resistance was confirmed during comparative tests in neutral salt spray carried out according to the standards ISO 9227 and ASTM B117, optionally after subjecting to the thermal shocks described above.

It was also confirmed that the coating does not reduce the fatigue strength of the parts treated; specifically, no reduction is recorded with regard to the initiating fatigue strength.

What is claimed is:

1. A process for the protection of a metal substrate of an aircraft part, in particular made of aluminum alloy, from corrosion and abrasion, characterized in that it comprises the formation, on said substrate, of a coating made of alloy of zinc and nickel and then the polishing of the coating thus formed.

2. The process of claim 1, characterized in that the formation of said coating comprises electrodeposition.

3. The process of claim 2, characterized in that the electrodeposition is carried out out-of-tank, in particular by brush plating.

4. The process of claim 2, characterized in that the electrodeposition comprises the use of an electrolytic solution having a concentration of Ni²⁺ ions of from 9 to 49 g/l and a concentration of Zn²⁺ ions of from 49 to 90 g/l.

5. The process of claim 4, characterized in that the source of Ni²⁺ ions comprises nickel chloride and the source of Zn²⁺ ions comprises zinc oxide, the electrolytic solution having a pH of from 8 to 10.

6. The process of claim 1, characterized in that the polishing is carried out by manual or mechanical sanding.

7. The process of claim 1, characterized in that the formation of the coating made of alloy of nickel and zinc and the polishing are carried out in order to obtain, before polishing, a coating with a thickness of from 30 to 50 μm and, after polishing, a coating with a thickness of from 20 to 45 μm.

8. The process of claim 1, further comprising: applying a transparent and air tight surface coating, to the polished coating made of alloy of zinc and nickel.

9. The process of claim 8, characterized in that said surface coating exhibits a thickness which can range up to 40 μm and comprise at least one polymer chosen from the group consisting of acrylic resins, epoxy resins, silicones, polysilanes, sol/gels and polyurethanes or is the result of a passivation without hexavalent chromium.

10. A metal substrate made of aluminum alloy, obtained by the method of claim 1, characterized in that the metal substrate comprises a coating composed of an alloy of zinc and nickel, this coating exhibiting a mirror finish appearance.

11. The substrate of claim 10, characterized in that the coating has a thickness of from 20 to 45 μm and comprises from 5 to 20% by weight of nickel.

12. The substrate of claim 11, characterized in that the substrate additionally comprises a transparent and airtight surface coating applied to the polished coating.
